(19) United States
(12) Patent Application Publication
(10) Pub. No.: US 2024/0400947 A1
(43) Pub. Date: Dec. 5, 2024

(54) Triamine-Based Disinfecting Cleaning Composition

(71) Applicant: ARXADA AG, Visp (CH)

(72) Inventors: Oxana Cesuina, Castleford, West Yorkshire (GB); Neil Scott Shaw, Castleford, West Yorkshire (GB); Aaron Thomas Arnold Nightingale, Castleford, West Yorkshire (GB); James Clarke, Castleford, West Yorkshire (GB); Emma Cooban, Castleford, West Yorkshire (GB)

(21) Appl. No.: 18/696,549

(22) PCT Filed: Oct. 20, 2022
(86) PCT No.: PCT/EP2022/079296

§ 371 Date: Mar. 28, 2024

(30) Foreign Application Priority Data
Oct. 21, 2021 (EP) 21204013.3

(51) Int. Cl. C11D 3/48; C11D 1/08; C11D 1/72; C11D 1/83; C11D 1/94; C11D 3/00; C11D 3/20; C11D 3/30; C11D 3/33

(52) U.S. Cl. CPC C11D 3/48; C11D 1/08; C11D 1/72; C11D 1/83; C11D 1/94; C11D 3/0047; C11D 3/2086; C11D 3/30; C11D 3/33; C11D 2111/24

(57) ABSTRACT

The invention relates to a disinfecting cleaning compositions comprising at least one triamine-based antimicrobial agent, at least one pH-dependent anionic surfactant and at least one non-ionic surfactant, which delivers effective disinfection, cleaning and low streaking or visual residues on surfaces.

### TECHNICAL FIELD

The invention relates to a disinfecting cleaning compositions comprising at least one triamine-based antimicrobial agent, at least one pH-dependent anionic surfactant and at least one non-ionic surfactant. The disinfecting cleaning compositions of the invention deliver effective disinfection using only low amounts of antimicrobial agent, and exhibit good cleaning and low streaking and/or visual residues on surfaces.

### TECHNOLOGICAL BACKGROUND

A disinfecting cleaning composition refers to any composition comprising both, a cleaning and a disinfecting effect. The disinfecting effect is thereby achieved by an antimicrobial agent capable of killing, destroying, or inhibiting the growth of organisms, particularly microorganisms. Products comprising disinfecting cleaning compositions include hard surface cleaners, hand sanitizers, pre-disinfectant cleaners for instruments, sterilizing and high-level disinfecting cleaning compositions, and the like. Ideally, the antimicrobial agent has broad-spectrum activity against all types of microorganisms. Furthermore the exposure time of the disinfecting cleaning composition to the surface should be as short as possible. The disinfecting cleaning composition should also have high efficacy so that a minimum amount of the anti-microbial agent can be used to save cost and to avoid or reduce any possible adverse effects caused by the anti-microbial agent. Moreover, the exposure of the end user to the antimicrobial agent can be minimized using low amounts of the anti-microbial agent and/or short exposure times. It is also desirable that the disinfecting cleaning composition cleans surfaces effectively, with low streaking and/or low visual residues on the surfaces. Moreover, it is also preferable that the disinfecting cleaning compositions delivers a stable product pH value even on dilution. The combination of amine-based antimicrobial agents and non-ionic surfactants is known in the art. The use of non-ionic surfactants alone in such compositions is less effective for cleaning than the combined use of non-ionic and pH-dependent anionic surfactants. It is, however, known that anionic surfactants are usually antagonistic to amine-based antimicrobial agents and jeopardize their anti-microbial efficacy, and therefore, disinfectant cleaners comprising anionic surfactants generally require a higher end-use level of the amine-based antimicrobial agents.

It has been surprisingly found by the present inventors that a disinfecting cleaning composition comprising low levels of at least one triamine-based antimicrobial agent together with at least one non-ionic surfactant and at least one pH-dependent anionic surfactant solves the above problems, as it is both, efficacious as a biocidal composition, and offers good cleaning efficiency on greasy and particulate soils. It also delivers a stable product pH-level even after dilution.

### SUMMARY OF THE INVENTION

It is an object of the present invention to provide a disinfecting cleaning composition, which is effective in cleaning and disinfection. The present disinfecting cleaning composition comprises low amounts of at least one triamine-based antimicrobial agent in combination with at least one non-ionic surfactant and at least one pH-dependent anionic surfactant having an isoelectric point (IEP) higher than pH 0 and lower than the pH of said disinfecting cleaning composition; said composition has a pH of from 8.5 to 12.

The combination of at least one triamine-based antimicrobial agent, at least one pH-dependent anionic surfactant and one non-ionic surfactant at this specific pH range allows to reduce the amount of the triamine-based antimicrobial agent required for high antimicrobial efficacy. The specific pH of from 8.5 to 12 is high enough to ensure that the above surfactants are in their anionic form, and at the same time low enough to ensure the biocidal efficacy of the triamine-based antimicrobial agent. Furthermore, the disinfecting cleaning composition does essentially not comprise, and is preferably free of the widely used biocidal active quaternary ammonium compounds. Additionally, the disinfecting cleaning composition is essentially free, preferably free of non-aqueous solvents. This renders the disinfecting cleaning composition of the invention less harmful to the environment and/or applicable to many solvent-unstable surfaces. Surprisingly, the effectiveness of the disinfecting cleaning composition of the invention in cleaning effects is not lowered despite the presence of an anionic surfactant, and the antimicrobial effect is even increased. The disinfecting cleaning composition delivers highly effective disinfection, cleaning and low streaking and/or visual residues on surfaces.

### BRIEF DESCRIPTION OF THE DRAWINGS

FIGS. 1 and 2 show the results of a cleaning test performed on a hard surface with a composition of the invention (Composition I.1 (“C I.1”) in a 1:100 dilution (“RTU C I.1”), cf., Table 1, with water, and with two comparative compositions (Compositions A and B).

FIG. 1 shows the results of a hard surface after cleaning with the above composition of the invention (Composition I.1 (C I.1) in a 1:100 dilution, (“RTU C I.1”), cf. Table 1, water, and with the two comparative compositions (Compositions A and B).

FIG. 2 is a column chart and shows the cleaning efficacy of the composition of the invention (Composition I.1 in a 1:100 dilution (“RTU C I.1”), cf. Table 1), of water, and of the two comparative compositions (Compositions A and B).

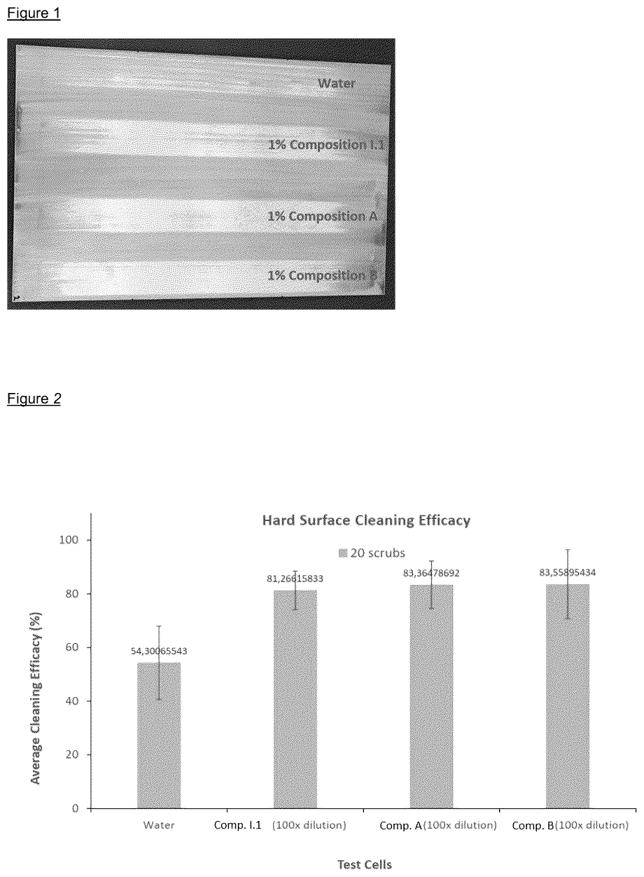

As derivable from FIGS. 1 and 2, the cleaning performance of Composition I and of Compositions A and B was superior to water, and in parity with each other.

### DETAILED DESCRIPTION

As used in the present disclosure and claims, the singular forms “a”, “an” and “the” include plural forms unless the context clearly dictates otherwise.

A pH range recited herein, such as “a pH of 8.5 to 12” includes the recited values, and all values in between such as pH 8.6, 8.7, 8.8, 8.9, 9, 9.1, 9.2, 9.3, 9.4, 9.5, 9.6, 9.7, 9.8, 9.9, 10, 10.1, 10.2, 10.3, 10.4, 10.5, 10.6, 10.7, 10.8, 10.9, 11, 11.1, 11.2, 11.3, 11.4, 11.5, 11.6, 11.7, 11.8, and 11.9. The pH can be measured as commonly known in the art, e.g., at 25° C. using a standard glass bulb pH meter.

Unless specifically stated otherwise, the term “%” or “percentage” as used herein refers to “weight percentage” (also referred to as “wt-%” herein).

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). The “alkyl” or “alkyl group” as used herein comprises between 1 and 30 carbon atoms (C1-C30), preferably between 1 and 24 carbon atoms, more preferably between 1 and 16 carbon atoms, even more preferably between 1 and 8 carbon atoms.

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

The present disclosure is generally directed to a disinfecting cleaning composition for disinfecting and cleaning surfaces. As used herein the term “disinfecting cleaning composition” can be understood as any composition comprising both, a cleaning and a disinfection effect. The disinfecting cleaning compositions not only deliver fast initial antimicrobial kill over a broad spectrum of microorganisms, but may also provide antimicrobial activity over an extended period of time.

In general, the disinfecting cleaning composition of the invention comprises at least one triamine-based antimicrobial agent, at least one pH-dependent anionic surfactant, and at least one non-ionic surfactant, and has a pH of from 8.5 to 12. The at least one pH-dependent anionic surfactant has an isoelectric point (IEP) lower than the pH of said disinfecting cleaning composition, but higher than pH 0. The combination of specific pH-dependent anionic surfactant and the non-ionic surfactant together with the triamine-based antimicrobial agent provides high antimicrobial efficacy at a pH of from 8.5 to 12, and is able to kill a broad spectrum of microorganisms in a short period of time in the presence of only low amounts of the antimicrobial agent. Therefore, the exposure of the end user to the antimicrobial agent is minimized. The use of a triamine-based antimicrobial agent provides that the maximal resilience of biocidal activity in the presence of pH-dependent anionic surfactant can be achieved.

### The Triamine-Based Antimicrobial Agent

The “triamine-based antimicrobial agent” present in the compositions of the invention is active against microorganisms, and has the potential to kill at least one microorganism and/or to control the growth of the microorganisms. The growth of microorganisms can be controlled in that the growth rate of the microorganism is reduced or completely inhibit.

As used herein, the term “microorganism” refers to any noncellular or unicellular (including colonial) organism. Microorganisms include all prokaryotes. Microorganisms include bacteria (including cyanobacteria), spores, lichens, fungi, protozoa, virinos, viroids, viruses, phages, and some algae. Various different microorganisms may be killed or controlled. For instance, the disinfecting cleaning composition can control gram positive bacteria, gram negative bacteria, and the like. In addition to bacteria, the anti-microbial composition of the present disclosure can also kill and control the growth of various other microorganisms, such as fungi, viruses, spores, yeast, mycobacteria, and the like. Examples of particular microorganisms that may be killed or controlled in accordance with the present disclosure include Staphylococcus aureus, Streptococcus pneumoniae, Pseudomonas aeruginosa, Serratia marcescens, Salmonella enteritidis, Neisseria gonorrhoeae, Escherichia coli, Enterococcus hirae, Acinetobacter baumannii, Listeria monocytogenes, Enterobacter gergoviae, Klebsiella pneumoniae, Burholderia cepacia, Pseudomonas putida, Kocuria rhizophila, Candida albicans, Saccharomyces cerevisiae, Aspergillus brasiliensis, Penicilfium funiculosum, Eupenicillium levitum, Bacillus cereus, Bacillus subtilis, Clostridium difficile, Clostridium perfringens, Mycobacterium tuberculosis, Mycobacterium terrae, Mycobacterium avium, Poliovirus, Adenovirus, Norovirus, Vaccinia virus, Influenza virus, Hepatitis B virus, Human Immunodeficiency virus, Human papilloma virus, or mixtures thereof. More preferably, the different microorganisms that may be killed or controlled by the disinfecting cleaning composition of the present invention can be Pseudomonas aeruginosa, Escherichia coli, Staphylococcus aureus, Enterococcus hirae and Candida albicans.

The triamine-based antimicrobial agent comprises three amino groups. The amino groups can each individually be a primary, secondary or tertiary amino group. In certain embodiments, at least one of the amino groups comprised in the triamine-based antimicrobial agent is a tertiary amino group. In certain embodiments, at least one of the amino groups comprised in the triamine-based antimicrobial agent is a primary amino group. In certain embodiments, the amino groups comprised in the triamine-based antimicrobial agent is at least one primary amino group and at least one tertiary amino group. In certain embodiments, the amino groups comprised in the triamine-based antimicrobial agent are two primary amino group and one tertiary amino group.

The at least one triamine-based antimicrobial agent can be selected from the group consisting of N-(3-aminopropyl)-N-dodecylpropane-1,3-diamine, N-(3-aminopropyl)-N-decyl-1,3-propanediamine, N-(3-aminopropyl)-N-tetradecyl-1,3-propanediamine, and combinations thereof; preferably the antimicrobial agent is N-(3-aminopropyl)-N-dodecylpropane-1,3-diamine.

It is understood that successful microbial reduction is achieved when the microbial populations are reduced by at least about 25%, preferably by at least about 50%, more preferably by at least about 75% or by significantly more than is achieved by a washing with water. Larger reductions in microbial population provide greater levels of protection.

The disinfecting cleaning composition of the invention is essentially free, preferably free of biocidal active quaternary ammonium compounds. As used herein, “essentially free of” means that the compositions may include very low amounts of the respective components, e.g., of less than 10 wt-% of the composition, more preferably less than 5 wt-%, 3 wt-%, 1 wt-%, 0.5 wt-% or 0.3 wt % of the composition.

The disinfecting cleaning compositions of the invention comprise biocidal active quaternary ammonium compounds in an amount of less than 1 wt-%, preferably less than 0.5 wt-%, more preferably less than 0.3 wt-%. It is, however, preferred, that no biocidal active quaternary ammonium compounds are present therein.

“Biocidal active quaternary ammonium compounds” are known to the skilled artisan, and are, for example alkyldimethylbenzyl ammonium chlorides, dialkylmethylbenzyl ammonium chlorides, dialkyldimethyl ammonium chlorides, alkyl dimethyl ethylbenzyl quaternary ammonium chlorides, benzethonium chloride, or non-halide quaternary compounds such as didecylmethylpoly(oxyethyl) ammonium propionate.

pH

Generally, the disinfecting cleaning composition has a pH of from 8.5 to 12. The pH value is preferably independent from the concentration of the composition, i.e., the composition will exhibit similar pH values in the concentrated form as well as in a diluted, ready-to-use (RTU) form. “Similar pH values” means that the pH value changes only slightly by a value of less than 2, preferably less than 1.5, more preferably less than 1 and even more preferably less than 0.5.

The disinfecting cleaning composition has a pH from 8.5 to 12, preferably of from 9 to 11. In the RTU form, the disinfecting cleaning composition has likewise a pH from 8.5 to 12, but preferably a pH from 8.5 to 10.5, and more preferably from a pH 9 to 10.

Due to this mild pH range, the disinfecting cleaning composition in the RTU form is particularly environmentally friendly, and therefore also suitable for pH sensitive surfaces. The specific pH range from 8.5 to 12 ensures that the least one pH-dependent anionic surfactant is present in anionic form to provide a high cleaning efficacy of the surfactants, but is low enough to ensure a high biocidal efficacy of the triamine-based antimicrobial agent.

### Surfactants

The disinfecting cleaning composition comprises a beneficial combination of at least one pH-dependent anionic surfactant having an isoelectric point (IEP) higher than pH 0 and lower than the pH of said disinfecting cleaning composition, and at least one non-ionic surfactant. It has been surprisingly found that the combined use of these particular surfactants together with a triamine-based antimicrobial agent allows to reduce the amount of the triamine-based antimicrobial agent required for high antimicrobial efficacy. The compositions of the invention exhibit high cleaning efficacy and low streaking and/or visual residues on hard surfaces.

Said at least one triamine-based antimicrobial agent and said two types of surfactants are present in the disinfecting cleaning composition of the invention in a ratio of between 1:08 to 1:4, preferably of between 1:1 and 1:2, and more preferably between 1:1 and 1:1.5 of the total amount of the at least one triamine-based antimicrobial agent to the total amount of these surfactants comprised therein.

pH-Dependent Anionic Surfactant

As used herein the term “anionic surfactant” is generally understood as surface active substance, which is categorized as “anionic” surfactant because of its negative charge; this term also includes surfactants, in which the molecule carries no charge unless the pH is elevated to neutrality or above (e.g., carboxylic acids).

The pH range at which such a molecule carries no net electrical charge (i.e., is electrically neutral in the statistical mean) is referred to as the “isoelectric range”. The mean of that isoelectric range is referred to as isoelectric point (IEP). The isoelectric point of a molecule can be measured by methods known in the art. For example the isoelectric range can be measured by isoelectric focusing. Another method to determine the IEP is titration.

The “net charge” of a pH dependent anionic surfactant is affected by the pH of its surrounding environment and can become positively or negatively charged due to the gain or loss of protons (H⁺). The term “net charge of molecule is neutral” can be understood in that the number of negative charge is equal to the number of positive charge on the molecule or the molecule is uncharged. The net charge of a molecule that is neutral is zero.

The present disclosure distinguishes between “pH dependent anionic surfactants” and “permanently anionic surfactants”. A “pH dependent anionic surfactant” is defined to have an isoelectric point (IEP) higher than pH 0 (pH >0) and lower than the pH of the disinfecting cleaning composition of the invention. This means that this type of anionic surfactant will be present in anionic form the pH range of the disinfecting cleaning composition disclosed herein, and when lowering the pH to 0, all negative charges in this molecule will be neutralized by protonation in these pH-dependent anionic surfactants.

In contrast, “permanently anionic surfactants” are defined to have an isoelectric point at pH 0 or below (pH≤0). This means that this type of anionic surfactant will stay in anionic form when lowering the pH from alkaline range to 0.

In the disinfecting cleaning compositions of the invention, the at least one pH-dependent anionic surfactant must have an isoelectric point (IEP) higher than pH 0 and lower than the pH of said disinfecting cleaning composition to ensure high antimicrobial activity of the at least one triamine-based antimicrobial agent.

The pH dependent anionic surfactant used in the composition according to the invention typically possess no biocidal activity.

The at least one pH-dependent anionic surfactant may be selected from the group consisting of alkyl carboxylates, alkyl ether carboxylates, alkyl propionates, alkyl ether propionates, amino acid-based surfactants, and combinations thereof.

Suitable amino acid-based surfactants include, but are not limited to, alkyl glutamates, alkyl alaninates, alkyl glycinates and alkyl sarcosinates.

In preferred embodiments, the pH-dependent anionic surfactant is an amino-acid based surfactant selected from the group consisting of alkyl alaninates, alkyl glutamates, alkyl sarcosinates, alkyl glycinates, alkyl aspartates, and combinations thereof.

In certain embodiments, the pH-dependent anionic surfactant is selected from the group consisting of ß-alanine, N-(2-carboxyethyl) N-coco alkyl derivatives, sodium N-(2-carboxyethyl)-N-(2-ethylhexyl)-β-alaninate, sodium N-(2-carboxyethyl)-N-octyl-β-alaninate, ß-alanine N-(2-carboxyethyl) N-tallow alkyl derivatives, sodium cocoyl alaninate, sodium lauroyl alaninate, sodium N-dodecanoyl-L-alaninate, sodium cocoyl glutamate, disodium cocoyl glutamate, ammonium cocoyl glutamate, diammonium cocoyl glutamate, sodium lauroyl glutamate, disodium lauroyl glutamate, sodium cocoyl hydrolyzed wheat protein glutamate, disodium cocoyl hydrolyzed wheat protein glutamate, potassium cocoyl glutamate, dipotassium cocoyl glutamate, potassium lauroyl glutamate, dipotassium lauroyl glutamate, potassium cocoyl hydrolyzed wheat protein glutamate, dipotassium cocoyl hydrolyzed wheat protein glutamate, sodium capryloyl glutamate, disodium capryloyl glutamate, potassium capryloyl glutamate, dipotassium capryloyl glutamate, sodium undecylenoyl glutamate, disodium undecylenoyl glutamate, potassium undecylenoyl glutamate, dipotassium undecylenoyl glutamate, disodium hydrogenated tallow glutamate, sodium stearoyl glutamate, disodium stearoyl glutamate, potassium stearoyl glutamate, dipotassium stearoyl glutamate, sodium myristoyl glutamate, disodium myristoyl glutamate, potassium myristoyl glutamate, dipotassium myristoyl glutamate, sodium cocoyl/hydrogenated tallow glutamate, sodium cocoyl/palmoyl/sunfloweroyl glutamate, sodium hydrogenated tallowoyl glutamate, sodium olivoyl glutamate, disodium olivoyl glutamate, sodium palmoyl glutamate, disodium palmoyl Glutamate, TEA-cocoyl glutamate, TEA-hydrogenated tallowoyl glutamate, TEA-lauroyl glutamate, sodium lauroyl sarcosinate, sodium cocoyl sarcosinate, sodium myristoyl sarcosinate, TEA-cocoyl sarcosinate, ammonium cocoyl sarcosinate, ammonium lauroyl sarcosinate, dimer dilinoleyl bis-lauroylglutamate/lauroylsarcosinate, disodium lauroamphodiacetate lauroyl sarcosinate, isopropyl lauroyl sarcosinate, potassium cocoyl sarcosinate, potassium lauroyl sarcosinate, sodium cocoyl sarcosinate, sodium lauroyl sarcosinate, sodium myristoyl sarcosinate, sodium oleoyl sarcosinate, sodium palmitoyl sarcosinate, TEA-cocoyl sarcosinate, TEA-lauroyl sarcosinate, TEA-oleoyl sarcosinate, TEA-palm kernel sarcosinate, sodium cocoyl glycinate, sodium lauroyl glycinate, sodium N-lauroyl aspartate, sodium N-dodecyl aspartate, and combinations thereof.

In preferred embodiments, the pH-dependent anionic surfactant is selected from the group consisting of ß-alanine, N-(2-carboxyethyl) N-coco alkyl derivatives, sodium N-(2-carboxyethyl)-N-(2-ethylhexyl)-β-alaninate, sodium N-(2-carboxyethyl)-N-octyl-β-alaninate, ß-alanine N-(2-carboxyethyl) N-tallow alkyl derivatives, sodium cocoyl alaninate, sodium lauroyl alaninate, sodium N-dodecanoyl-L-alaninate, and combinations thereof.

In more preferred embodiments, the at least one pH-dependent anionic surfactant is sodium N-(2-carboxyethyl)-N-(2-ethylhexyl)-β-alaninate.

In another preferred embodiment, the disinfecting cleaning composition comprises sodium N-(2-carboxyethyl)-N-(2-ethylhexyl)-β-alaninate and at least one further pH-dependent anionic surfactant of the pH-dependent anionic surfactant as described above.

In another preferred embodiment, the disinfecting cleaning composition comprises sodium N-(2-carboxyethyl)-N-(2-ethylhexyl)-β-alaninate and at least one further pH-dependent anionic surfactant selected from the group ß-alanine, N-(2-carboxyethyl) N-coco alkyl derivatives, sodium N-(2-carboxyethyl)-N-octyl-β-alaninate, ß-alanine, N-(2-carboxyethyl) N-tallow alkyl derivatives, sodium cocoyl alaninate, sodium lauroyl alaninate, sodium N-dodecanoyl-L-alaninate, and combinations thereof.

The term “N-(2-carboxyethyl) N-coco alkyl derivatives” as used herein comprises alkyl residues of C1 to C22, preferably C2 to C16 atoms. These deviates can be in form of sodium salts. For example, the “ß-alanine, N-(2-carboxyethyl) N-coco alkyl derivatives” may be a substance that is commercially available and has the CAS number [90170-43-7].

The term “N-(2-carboxyethyl) N-tallow alkyl derivatives” used herein comprises alkyl residues of C1 to C22, preferably C2 to C16 atoms. These deviates can be in form of sodium salts. For example, the “ß-alanine, N-(2-carboxyethyl) N-tallow alkyl derivative” may be a substance that is commercially available and has the CAS number [61791-56-8].

As used herein, the abbreviation “TEA” in compounds such as “TEA-cocoyl glutamate” refers to “triethanolamine”.

In certain embodiments, the composition of the invention comprises from 10 wt-% to 50 wt-%, preferably from 15 wt-% to 35 wt-%, 17.5 wt-% to 30 wt-%, and more preferably from 20 wt-% to 25 wt-% of said at least one pH-dependent anionic surfactant(s) based on the total weight of surfactants comprised in said composition.

In certain embodiments, the composition of the invention comprises at least 10 to 35 wt-%, preferably at least 15 to 30 wt-% and more preferably 20 to 25 wt-% of said at least one pH-dependent anionic surfactant(s) based on the total weight of surfactants comprised in said composition.

### Non-Ionic Surfactant

The term “non-ionic surfactant” refers to surfactants that are generally characterized by the presence of an organic hydrophobic group and an organic hydrophilic group; non-ionic surfactants are known to the skilled artisan and are typically produced by the condensation of an organic aliphatic, alkyl aromatic or polyoxyalkylene hydrophobic compound with a hydrophilic alkaline oxide moiety, which in common practice is ethylene oxide or a polyhydration product thereof, polyethylene glycol.

Practically any hydrophobic compound having a hydroxyl, carboxyl, amino, or amido group with a reactive hydrogen atom can be condensed with ethylene oxide, or its polyhydration adducts, or its mixtures with alkoxylenes such as propylene oxide to form a non-ionic surface-active agent. The length of the hydrophilic polyoxyalkylene moiety, which is condensed with any particular hydrophobic compound, can be readily adjusted to yield a water dispersible or water soluble compound having the desired degree of balance between hydrophilic and hydrophobic properties.

Useful non-ionic surfactants include condensation products of one mole of a saturated or unsaturated, straight or branched chain alcohol having from about 6 to about 24 carbon atoms with from about 3 to about 50 moles of ethylene oxide. The alcohol moiety can consist of mixtures of alcohols in the above delineated carbon range or it can consist of an alcohol having a specific number of carbon atoms within this range.

Condensation products of one mole of saturated or unsaturated, straight or branched chain carboxylic acid having from about 8 to about 18 carbon atoms with from about 6 to about 50 moles of ethylene oxide. The acid moiety can consist of mixtures of acids in the above defined carbon atoms range or it can consist of an acid having a specific number of carbon atoms within the range. Examples of commercial compounds of this chemistry are available under the trade names Nopalcol™ manufactured by Henkel Corporation and Lipopeg™ manufactured by Lipo Chemicals, Inc. In addition to ethoxylated carboxylic acids, commonly called polyethylene glycol esters, other alkanoic acid esters formed by reaction with glycerides, glycerine, and polyhydric (saccharide or sorbitan/sorbitol) alcohols have application in this invention for specialized embodiments, particularly indirect food additive applications. All of these ester moieties have one or more reactive hydrogen sites on their molecule which can undergo further acylation or ethylene oxide (alkoxide) addition to control the hydrophilicity of these substances.

The alkyl ethoxylate condensation products of aliphatic alcohols with from about 0 to about 25 moles of ethylene oxide are suitable for use in the present compositions. The alkyl chain of the aliphatic alcohol can either be straight or branched, primary or secondary, and generally contains from 6 to 22 carbon atoms.

Moreover, suitable non-ionic surfactants may be alkylpolysaccharide surfactants. These surfactants include a hydrophobic group containing from about 6 to about 30 carbon atoms and a polysaccharide, such as a polyglycoside, hydrophilic group containing from about 1.3 to about 10 saccharide units. Any reducing saccharide containing 5 or 6 carbon atoms can be used, e.g., glucose, galactose and galactosyl moieties can be substituted for the glucosyl moieties. Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6-positions on the preceding saccharide units.

Other non-ionic surfactants that may be used in the composition, include, but are not limited to, polyoxyethylene glycol alkyl ethers, octaethylene glycol monododecyl ether, pentaethylene glycol monododecyl ether, polyoxypropylene glycol alkyl ethers, glycoside alkyl ethers, decyl glycoside, lauryl glycoside, octyl glycoside, polyoxyethylene glycol octylphenol ethers, polyoxyethylene glycol alkylphenol ethers, glycerol alkyl esters, polyglycerol esters, glyceryl laurate, polyoxyethylene glycol sorbitan alkyl esters, sorbitan alkyl esters, dodecyldimethylamine oxide, block copolymers of polyethylene glycol and polypropylene glycol, poloxamers and polyethoxylated tallow amine (POEA), and combinations thereof.

In certain embodiments, the non-ionic surfactant is selected from the group consisting of fatty alcohol ethoxylates, alkyl glucosides, alkyl polyglucosides, fatty acid ethoxylates, alkylphenol ethoxylates, poly(ethylene oxide)-poly(propylene oxide) block copolymers, and combinations thereof. Preferably, the non-ionic surfactant is selected from the group consisting of fatty alcohol ethoxylates, alkyl glucosides, alkyl polyglucosides, alkylphenol ethoxylates, poly(ethylene oxide)-poly(propylene oxide) block copolymers, and combinations thereof.

In certain embodiments, the non-ionic surfactant is selected from the group consisting of isotridecanol ethoxylate, C9-C11 alcohol ethoxylates, C12-C18 alcohol ethoxylates, and combinations thereof. In certain embodiments, the non-ionic surfactant is at least one C9-C11 alcohol ethoxylate.

The “C9-C11 alcohol ethoxylates”, or “C12-C18 alcohol ethoxylates” are often commercially available as mixtures. For example, Imbentin™ 0/91/060 is a “09-C11 alcohol ethoxylate” commercial product, e.g., available as “C9-11, branched and linear, ethoxylated” (CAS: [160901-09-7]). Another “C9-C11 alcohol ethoxylate” is available as “alcohols, C9-11, ethoxylated” (CAS: [68439-46-3]).

In another certain embodiment, the at least one non-ionic surfactant comprises at least one C9-C11 alcohol ethoxylate and a further non-ionic surfactant that is selected from the group consisting of fatty alcohol ethoxylates, alkyl glucosides, alkyl polyglucosides, alkylphenol ethoxylates, poly(ethylene oxide)-poly(propylene oxide) block copolymers, and combinations thereof.

### Further Ingredients

### Buffering Agent

The disinfecting cleaning compositions of the invention may further comprise a buffering agent. The “buffering agent” is an agent suitable to maintain the pH level of the composition of the invention, and is typically comprised of an acid and a (conjugated) base (and vice versa). pH stability can be important for certain compositions formulated in accordance with the present disclosure to ensure appropriate antimicrobial efficacy. Suitable buffering agents may be based on at least one organic acid, preferably a carboxylic acid. The at least one carboxylic acid may be acetic acid, glycolic acid, formic acid, citric acid, malic acid, maleic acid, lactic acid, tartaric acid, oxalic acid, and combinations thereof, which are used together with the conjugated bases of these acids, or mixtures thereof. Other suitable buffering agents are known to the skilled artisan.

Typically, less than 1% by weight of these acids are required to achieve the desired pH. A suitable amount may be readily determined by the skilled artisan. Preferably, the buffering agent may be tartaric acid.

The pH may be adjusted with hydrochloric acid or sodium hydroxide, or with a carboxylic acid, preferably tartaric acid.

### Amphoteric Surfactant

The disinfecting cleaning compositions disclosed herein may further comprise an “amphoteric surfactant”. An “amphoteric surfactant” is understood to be a surfactant that contains both, a basic and an acidic hydrophilic group, as well as an organic hydrophobic group. These ionic entities may be any of anionic or cationic groups described herein for other types of surfactants. A basic nitrogen and an acidic carboxylate group are the typical functional groups employed as the basic and acidic hydrophilic groups. In a few surfactants, sulfonate, sulphate, phosphonate or phosphate provide the negative charge.

A further kind of amphoteric surfactants are zwitterionic surfactants, such as a betaine surfactant. Zwitterionic surfactants can be thought of as a subset of the amphoteric surfactants and can include an anionic charge. Zwitterionic surfactants can be broadly described as derivatives of secondary and tertiary amines, derivatives of heterocyclic secondary and tertiary amines, or derivatives of quaternary ammonium, quaternary phosphonium or tertiary sulfonium compounds. Typically, a zwitterionic surfactant includes a positive charged quaternary ammonium or, in some cases, a sulfonium or phosphonium ion; a negative charged carboxyl group; and an alkyl group. Zwitterionics generally contain cationic and anionic groups which ionize to a nearly equal degree in the isoelectric region of the molecule and which can develop strong “inner-salt” attraction between positive-negative charge centers. Examples of such zwitterionic synthetic surfactants include derivatives of aliphatic quaternary ammonium, phosphonium, and sulfonium compounds, in which the aliphatic radicals can be straight chain or branched, and wherein one of the aliphatic substituents contains from 8 to 18 carbon atoms and one contains an anionic water solubilizing group, e.g., carboxyl, sulfonate, sulphate, phosphate, or phosphonate.

The amphoteric surfactants used in the composition according to the invention do not possess biocidal activity.

In certain embodiments, the disinfecting cleaning composition further comprises at least one amphoteric surfactant having an isoelectric point (IEP) higher than the pH of said disinfecting cleaning composition.

In certain embodiments, the amphoteric surfactant is selected from the group consisting of amine oxides, alkyl betaines, alkyl amidopropyl betaines, and combinations thereof.

In certain embodiments, the amphoteric surfactant may comprise a cocoamidopropyl betaine.

In certain embodiments, the amphoteric surfactant is selected from the group consisting of decyl betaine, myristyl betaine, palmityl betaine, lauryl betaine, cetyl betaine, stearyl betaine, coco dimethyl carboxymethyl betaine (“cocobetaine”), cocoamidoethyl betaine, cocoamidopropyl betaine, lauramidopropyl betaine, myristyl amidopropyl betaine, lauryl dimethyl carboxymethyl betaine, lauryl dimethyl alpha-carboxy-ethyl betaine, cetyl dimethylcarboxymethyl betaine, lauryl bis-(2-hydroxy-ethyl) carboxy methyl betaine, stearyl bis-(2-hydroxy-propyl) carboxymethylbetaine, oleyl dimethyl gamma-carboxypropyl betaine, lauryl bis-(2-hydroxypropyl) alpha-carboxyethyl betaine, cocoamidopropyl dimethyl betaine, and combinations thereof.

In certain embodiments, the amphoteric surfactant may comprise a polymeric betaine.

In certain embodiments, the amphoteric surfactant is selected from the group consisting of amine oxides, alkyl betaines, alkyl amidopropyl betaines and combinations thereof; preferably, the amphoteric surfactant is selected from the group consisting of N-alkyl(C6-18)-N,N-dimethylamine-N-oxide, octyl dimethyl amine oxide, decyl dimethyl amine oxide, lauryl dimethyl amine oxide, cocoalkyl dimethyl amine oxide, myristyl dimethyl amine oxide, octyl dimethyl amine oxide, decyl dimethyl amine oxide, lauryl dimethyl amine oxide, isoalkyl dimethyl amine oxide tetradecyl dimethyl amine oxide, cetyl dimethyl amine oxide, and combinations thereof.

In certain embodiments, the at least one amphoteric surfactant is N-alkyl(C6-18)-N,N-dimethylamine-N-oxide.

### Chelating Agent

The disinfecting cleaning compositions disclosed herein may further comprise a chelating agent. As used herein, the term “chelating agent” can be understood as a molecule capable of coordinating (i.e., binding) the metal ions commonly found in water sources to prevent the metal ions from interfering with the action of the other ingredients. Suitable chelating agents are known to the skilled person. Examples of chelating agents include phosphonic acid and phosphonates, phosphates, aminocarboxylates and their derivatives, pyrophosphates, ethylenediamine and ethylenetriamine derivatives, hydroxyacids, and mono-, di-, and tri-carboxylates and their corresponding acids. In certain embodiments, the composition is phosphate free.

Preferred chelating agents form calcium-chelating agent complexes with a stability constant (expressed in logarithmic form) of about 5.5 or greater. The calcium-chelating agent stability constant (K) is the measure of the stability of a calcium-chelating agent complex (CaL) formed by the reaction of a calcium ion (Ca) with a chelating agent (L) in aqueous solution.

Chelating agents include, for example, an acetic acid derivative selected from the group consisting of ethylenediaminetetraacetic acid (EDTA), nitrilotriacetic acid (NTA), L-Glutamic acid N,N-diacetic acid tetrasodium (GLDA).

The chelating agent may serve to bind other metal ions that may adversely affect the effectiveness of the disinfecting components in the composition. In addition, chelating agents may also assist in soil removal and/or preventing soil redeposition into the disinfecting composition while in use.

The disinfecting cleaning composition may comprise said at least one chelating agent in an amount of from 0.5 wt-% to 30 wt-%, preferably from 1.0 wt-% to 10 wt-% based on the total weight of the composition.

If the disinfecting cleaning composition is in a diluted, ready-to-use form, the amount of chelating agent will be correspondingly lower, e.g., form 0.005 wt-% to 0.3 wt-%, preferably from 0.01 wt-% to 0.10 wt-% based on the total weight of the composition in ready to use form.

In certain embodiments, the disinfecting cleaning composition comprises at least one chelating agent, preferably selected from the group comprising EDTA, methylglycinediacetic acid (MGDA), GLDA, NTA, β-alanine diacetate (β-ADA), imidodisuccinic acid (IDHA), citrates, gluconates, polystyrene sulfonates, and combinations thereof.

In a preferred embodiment, the at least one chelating agent is selected from the group comprising EDTA, MGDA, GLDA, and combinations thereof.

The at least one chelating agent may be in the form of the free acid or the corresponding salt thereof, preferably in the form of the sodium salt thereof.

In certain embodiments, the disinfecting cleaning composition comprises methylglycinediacetic acid trisodium salt (MGDA-Na3, Trilon M).

### Optional Further Ingredients

The disinfecting cleaning composition may comprise further optional ingredients, which include, but are not limited to, fragrances, product colorant, corrosion inhibitors, additional surfactants, dispersants, stabilizing agents, rheology modifiers, carriers, preservatives, bleaching agents and the like. Exemplary corrosion inhibitors include, for example, organic phosphorous compounds and blends of organic phosphorous compounds with a polymeric component. Product colorants may be included to alter the appearance of the composition. Fragrances or perfumes that may be included in the compositions include, for example, terpenoids such as citronellol, aldehydes such as amyl cinnamaldehyde, a jasmine such as C1S-jasmine or jasmal, vanillin, and the like. Product colorants and fragrances may be added provided they do not interfere with the function of the composition and may serve for identifying the composition.

Any of the above further ingredients may be present in the disinfecting cleaning compositions of the invention, irrespective of whether the composition is the form of a concentrate, or in a diluted, ready-to-use form (see below).

### Ready-to-Use (RTU) Form of the Disinfecting Cleaning Composition

The disinfecting cleaning composition of the invention may be diluted to provide a ready-to-use (RTU) form thereof (“RTU composition”).

The composition of the invention can be diluted in a single dilution or in stages to provide the “ready-to-use disinfecting cleaning composition” (“RTU composition”).

The composition of the invention can be diluted with any suitable amount of water. Terms such as “1:10”, “1:100”, “1:200” “1:500”, etc. are called “dilution factors”. In each of these dilution factors, the numerator “1” refers to the number of parts of the disinfecting cleaning composition, whereas the other number (e.g., 10, 100, 200, or 500) refers to the number of total parts of each dilution with water. For example, a disinfecting cleaning composition having a dilution factor of 1:1000, one part of the disinfecting cleaning composition can be diluted with 1000 parts water. In a preferred embodiment, the 1 part of the disinfecting cleaning composition is diluted with 50 to 500 parts water. More preferably, the disinfecting cleaning composition is diluted with 100 or 200 parts water for use.

Providing the disinfecting cleaning composition of the invention for subsequent dilution can be advantageous when it is desirable to package and ship the disinfecting cleaning composition instead of the diluted ready-to-use disinfecting cleaning composition. The ready-to-use disinfecting cleaning composition can be made available when the ready-to-use disinfecting cleaning composition is intended to be applied directly to a surface to provide cleaning and disinfection. For example, a disinfecting cleaning composition for use on glass can be referred to as a ready-to-use composition when it is intended to be applied directly to a glass surface for cleaning and disinfection.

Accordingly, the present disclosure further provides a ready-to-use composition comprising the disinfecting cleaning composition of the invention, which is diluted with 1 to 1000 parts of water, preferably with 50 to 500 parts water, or with 100 or 200 parts of water.

In the RTU form, the disinfecting cleaning composition has a pH from 8.5 to 12, but preferably a pH from 8.5 to 10.5, and more preferably a pH from 9 to 10.

In certain embodiments, the disinfecting cleaning composition comprises the at least one triamine-based antimicrobial agent in an amount of from 0.001 wt-% to 0.5 wt-%, preferably of from 0.005 wt-% to 0.1 wt-%, more preferably of from 0.01 wt-% to 0.25 wt-%, most preferably of from 0.05 wt-% to 0.1 wt-% based on the total weight of the composition in ready-to-use diluted form.

In certain embodiments, the disinfecting cleaning composition comprises the at least one pH-dependent anionic surfactant(s) in an amount of from 0.001 wt-% to 1.0 wt-%, preferably from 0.005 wt-% to 0.2 wt-%, more preferably from 0.01 wt-% to 0.1 wt-, most preferably from 0.015 wt-% to 0.05 wt-% based on the total weight of the composition in ready-to-use diluted form.

In certain embodiments, the disinfecting cleaning composition comprises from 10 wt-% to 50 wt-%, preferably from 15 wt-% to 35 wt-%, 17.5 wt-% to 30 wt-%, and more preferably from 20 wt-% to 25 wt-% of said at least one pH-dependent anionic surfactant(s) based on the total weight of surfactants comprised in said composition in ready-to-use diluted form.

In certain embodiments, the disinfecting cleaning composition comprises the at least one non-ionic surfactant in an amount of from 0.005 wt-% to 0.5 wt-%, preferably of from 0.01 wt-% to 0.2 wt-%, more preferably of from 0.02 wt-% to 0.1 wt-%, based on the total weight of the composition in ready-to-use diluted form.

Any combinations of the above are envisaged, such as the exemplarily described embodiments as follows.

In certain embodiments, the disinfecting cleaning composition is in the form of a ready-to-use composition having a pH from 8.5 to 10.5, and comprising
(a) said at least one triamine-based antimicrobial agent in an amount of from 0.001 wt-% to 0.5 wt-%, based on the total weight of the composition in ready-to-use diluted form;
(b) said at least one pH-dependent anionic surfactant(s) in an amount of from 0.001 wt-% to 1.0 wt-%, based on the total weight of the composition in ready-to-use diluted form; and
(c) said at least one non-ionic surfactant in an amount of from 0.005 wt-% to 0.5 wt-%, based on the total weight of the composition in ready-to-use diluted form.

In certain embodiments, the disinfecting cleaning composition is in the form of a ready-to-use composition having a pH from 8.5 to 10.5, and comprising
(a) said at least one triamine-based antimicrobial agent in an amount of from 0.01 wt-% to 0.25 wt-%, based on the total weight of the composition in ready-to-use diluted form;
(b) said at least one pH-dependent anionic surfactant(s) in an amount of from 0.01 wt-% to 0.1 wt-, based on the total weight of the composition in ready-to-use diluted form; and
(c) said at least one non-ionic surfactant in an amount of from 0.01 wt-% to 0.2 wt-%, based on the total weight of the composition in ready-to-use diluted form.

In certain embodiments, the disinfecting cleaning composition is in the form of a ready-to-use composition having a pH from 8.5 to 10.5, and comprising
(a) said at least one triamine-based antimicrobial agent in an amount of from 0.05 wt-% to 0.1 wt-% based on the total weight of the composition in ready-to-use diluted form;
(b) said at least one pH-dependent anionic surfactant(s) in an amount of from 0.015 wt-% to 0.05 wt-% based on the total weight of the composition in ready-to-use diluted form; and
(c) said at least one non-ionic surfactant in an amount of from 0.02 wt-% to 0.1 wt-%, based on the total weight of the composition in ready-to-use diluted form.

In a certain embodiment, the disinfecting cleaning composition is in the form of a ready-to-use composition as defined herein above, and further comprises at least one chelating agent in an amount of from 0.005 wt-% to 0.3 wt-%, preferably from 0.01 wt-% to 0.10 wt-% based on the total weight of the composition in ready to use form.

In a certain embodiment, the disinfecting cleaning composition is in the form of a ready-to-use composition as defined herein above, and further comprises at least one amphoteric surfactant in an amount of from 0.001 wt-% to 0.15 wt-%, preferably of from 0.007 wt-% to 0.04 wt-% based on the total weight of the composition in ready to use form.

In a certain embodiment, the disinfecting cleaning composition is in the form of a ready-to-use composition as defined herein above, and further comprises at least one non-aqueous solvent in an amount of from 0.01 wt-% to 0.1 wt-% preferably of from 0.01 wt-% to 0.05 wt-% based on the total weight of the composition in ready to use form. The solvent may be an organic solvent, and may include, but is not limited to, isopropyl alcohol, glycerine, propylene glycol, ethanol, poly(ethylene glycol), DL-1,2-isopropylideneglycerol, mineral oils, paraffin oils, benzene, petroleum distillates, naphtha, acetone, methyl ethyl ketone, toluene, n-propylbromide, and trichloroethylene (TCE) and the like.

In a certain embodiment, the disinfecting cleaning composition is in the form of a ready-to-use composition as defined above, and further comprises DL-1,2-isopropylideneglycerol.

In a certain embodiment, the disinfecting cleaning further comprises DL-1,2-isopropylideneglycerol.

While a non-aqueous solvent may be present, the disinfecting cleaning compositions of the invention may also be essentially free, preferably free, of non-aqueous solvents and/or quaternary ammonium compounds.

The use of essentially only water and a low amount of the triamine-based antimicrobial agent renders the disinfecting cleaning composition of the invention less harmful to the environment and/or applicable to many solvent-unstable surfaces such as coated materials, which are sensitive to solvents and/or frictions.

As used herein, “essentially free of” means that the compositions may include very low amounts of the respective components, e.g., of less than 10 wt-% in the disinfecting cleaning composition, and less than 0.1 wt-% in the RTU form or preferably less than 0.05 wt-%, 0.03 wt-%, 0.01 wt-%, 0.005 wt-% or 0.003 wt % of the composition in RTU form.

In the diluted ready-to-use form of the disinfecting cleaning composition (RTU composition), the non-aqueous solvent may present in an amount of less than 0.1 wt-%, preferably less than 0.05 wt-%, more preferably less than 0.03 wt-% in the RTU disinfecting cleaning composition, and most preferably, does not comprise any non-aqueous solvent at all.

In disinfecting cleaning composition, the non-aqueous solvent is present in an amount of less than 10 wt-%, preferably less than 5 wt-%, more preferably less than 3 wt-%. In certain embodiments, the disinfecting cleaning composition does not comprise any non-aqueous solvent at all.

In the diluted ready-to-use form of the disinfecting cleaning composition (RTU composition), biocidal active quaternary ammonium compounds may only present in an amount of less than 0.01 wt-%, preferably less than 0.005 wt-%, more preferably less than 0.003 wt-%. It is, however, preferred that the RTU disinfecting cleaning composition does not comprise any biocidal active quaternary ammonium compound at all.

### FURTHER EMBODIMENTS OF THE INVENTION

In one embodiment, the invention provides a disinfecting cleaning composition comprising
(a) at least one triamine-based antimicrobial agent;
(b) at least one pH-dependent anionic surfactant; and
(c) at least one non-ionic surfactant;
wherein the composition is in ready-to-use form having a pH from 8.5 to 10.5, and
wherein the at least one pH-dependent anionic surfactant has an isoelectric point (IEP) higher than pH 0 and lower than the pH of said disinfecting cleaning composition.

In one embodiment, the invention provides a disinfecting cleaning composition comprising
(a) at least one triamine-based antimicrobial agent;
(b) at least one pH-dependent anionic surfactant; and
(c) at least one non-ionic surfactant,
wherein the composition has a pH of from 8.5 to 12, wherein the at least one pH-dependent anionic surfactant has an isoelectric point (IEP) higher than pH 0 and lower than the pH of said disinfecting cleaning composition, and
wherein the at least one triamine-based antimicrobial agent is selected from the group consisting of N-(3-aminopropyl)-N-dodecylpropane-1,3-diamine, N-(3-aminopropyl)-N-decyl-1,3-propanediamine, N-(3-aminopropyl)-N-tetradecyl-1,3-propanediamine, and combinations thereof, preferably N-(3-aminopropyl)-N-dodecylpropane-1,3-diamine. Optionally the composition comprises a buffering agent. Optionally said composition has a ratio of the total amount of said triamine based antimicrobial agent to the total amount of surfactants, which is between 1:1 to 1:4.

In one embodiment, the invention provides a disinfecting cleaning composition is in form of a RTU composition comprising
(a) at least one triamine-based antimicrobial agent;
(b) at least one pH-dependent anionic surfactant; and
(c) at least one non-ionic surfactant,
wherein the composition has a pH of from 8.5 to 10.5, wherein the at least one pH-dependent anionic surfactant has an isoelectric point (IEP) higher than pH 0 and lower than the pH of said disinfecting cleaning composition, and
wherein the at least one triamine-based antimicrobial agent is N-(3-aminopropyl)-N-dodecylpropane-1,3-diamine. Said RTU composition can comprise said N-(3-aminopropyl)-N-dodecylpropane-1,3-diamine in an amount of at most 0.15 wt-%, preferably 0.1 wt-%, based on the total weight of the composition. Optionally, said RTU composition comprises a buffering agent.

Optionally said RTU composition has a ratio of the total amount of N-(3-aminopropyl)-N-dodecylpropane-1,3-diamine to the total amount of surfactants, which is between 1:1 to 1:4.

In one embodiment, the invention provides a disinfecting cleaning composition comprising
(a) at least one triamine-based antimicrobial agent;
(b) at least one pH-dependent anionic surfactant; and
(c) at least one non-ionic surfactant,
wherein the composition has a pH of from 8.5 to 12, and
wherein the at least one triamine-based antimicrobial agent is selected from the group consisting of N-(3-aminopropyl)-N-dodecylpropane-1,3-diamine, N-(3-aminopropyl)-N-decyl-1,3-propanediamine, N-(3-aminopropyl)-N-tetradecyl-1,3-propanediamine, or combinations thereof;
wherein the at least one pH-dependent anionic surfactant is selected from the group consisting alkyl carboxylates, alkyl ether carboxylates, alkyl propionates, alkyl ether propionates, amino acid-based surfactants, and combinations thereof; and
wherein the at least one non-ionic surfactant is selected from the group consisting of ß-alanine, N-(2-carboxyethyl) N-coco alkyl derivatives, sodium N-(2-carboxyethyl)-N-(2-ethylhexyl)-β-alaninate, sodium N-(2-carboxyethyl)-N-octyl-β-alaninate, ß-alanine N-(2-carboxyethyl) N-tallow alkyl derivatives, sodium cocoyl alaninate, sodium lauroyl alaninate, sodium N-dodecanoyl-L-alaninate, and combinations thereof.

Optionally said composition comprises a buffering agent.

The at least one buffering agent may comprise at least one organic acid, preferably wherein the organic acid is a carboxylic acid preferably selected from the group consisting of acetic acid, glycolic acid, formic acid, citric acid, malic acid, maleic acid, lactic acid, tartaric acid, oxalic acid, and combinations thereof.

In one embodiment, the invention provides a disinfecting cleaning composition comprising
(a) at least one triamine-based antimicrobial agent;
(b) at least one pH-dependent anionic surfactant; and
(c) at least one non-ionic surfactant;
wherein the composition has a pH of from 8.5 to 12,
wherein the at least one triamine-based antimicrobial agent is N-(3-aminopropyl)-N-dodecylpropane-1,3-diamine;
wherein the at least one pH-dependent anionic surfactant is selected from the group consisting alkyl carboxylates, alkyl ether carboxylates, alkyl propionates, alkyl ether propionates, amino acid-based surfactants, and combinations thereof; and
wherein the at least one non-ionic surfactant is selected from the group consisting of ß-alanine, N-(2-carboxyethyl) N-coco alkyl derivatives, sodium N-(2-carboxyethyl)-N-(2-ethylhexyl)-β-alaninate, sodium N-(2-carboxyethyl)-N-octyl-β-alaninate, ß-alanine N-(2-carboxyethyl) N-tallow alkyl derivatives, sodium cocoyl alaninate, sodium lauroyl alaninate, sodium N-dodecanoyl-L-alaninate, and combinations thereof.

Optionally said composition comprises a buffering agent.

The at least one buffering agent may comprise at least one organic acid, preferably wherein the organic acid is a carboxylic acid preferably selected from the group consisting of acetic acid, glycolic acid, formic acid, citric acid, malic acid, maleic acid, lactic acid, tartaric acid, oxalic acid, and combinations thereof.

In one embodiment, the invention provides a disinfecting cleaning composition comprising
(a) at least one triamine-based antimicrobial agent;
(b) at least one pH-dependent anionic surfactant; and
(c) at least one non-ionic surfactant;
wherein the composition has a pH of from 8.5 to 12,
wherein the at least one triamine-based antimicrobial agent is selected from the group consisting of N-(3-aminopropyl)-N-dodecylpropane-1,3-diamine, N-(3-aminopropyl)-N-decyl-1,3-propanediamine, N-(3-aminopropyl)-N-tetradecyl-1,3-propanediamine, or combinations thereof;
wherein the at least one pH-dependent anionic surfactant is at least one amino acid-based surfactant; and
wherein the at least one non-ionic surfactant is selected from the group consisting of ß-alanine, N-(2-carboxyethyl) N-coco alkyl derivatives, sodium N-(2-carboxyethyl)-N-(2-ethylhexyl)-β-alaninate, sodium N-(2-carboxyethyl)-N-octyl-β-alaninate, ß-alanine N-(2-carboxyethyl) N-tallow alkyl derivatives, sodium cocoyl alaninate, sodium lauroyl alaninate, sodium N-dodecanoyl-L-alaninate, and combinations thereof.

Optionally said composition comprises a buffering agent.

The at least one buffering agent may comprise at least one organic acid, preferably wherein the organic acid is a carboxylic acid preferably selected from the group consisting of acetic acid, glycolic acid, formic acid, citric acid, malic acid, maleic acid, lactic acid, tartaric acid, oxalic acid, and combinations thereof.

In one embodiment, the invention provides a disinfecting cleaning composition comprising
(a) at least one triamine-based antimicrobial agent;
(b) at least one pH-dependent anionic surfactant; and
(c) at least one non-ionic surfactant;
wherein the composition has a pH of from 8.5 to 12,
wherein the at least one triamine-based antimicrobial agent is N-(3-aminopropyl)-N-dodecylpropane-1,3-diamine;
wherein the at least one pH-dependent anionic surfactant is at least one amino acid-based surfactant;
wherein the at least one non-ionic surfactant is selected from the group consisting of ß-alanine, N-(2-carboxyethyl) N-coco alkyl derivatives, sodium N-(2-carboxyethyl)-N-(2-ethylhexyl)-β-alaninate, sodium N-(2-carboxyethyl)-N-octyl-β-alaninate, ß-alanine N-(2-carboxyethyl) N-tallow alkyl derivatives, sodium cocoyl alaninate, sodium lauroyl alaninate, sodium N-dodecanoyl-L-alaninate, and combinations thereof; and
at least one buffering agent comprising at least one organic acid, preferably wherein the organic acid is a carboxylic acid preferably selected from the group consisting of acetic acid, glycolic acid, formic acid, citric acid, malic acid, maleic acid, lactic acid, tartaric acid, oxalic acid, and combinations thereof.

In one embodiment, the invention provides a disinfecting cleaning composition comprising
(a) at least one triamine-based antimicrobial agent;
(b) at least one pH-dependent anionic surfactant; and
(c) at least one non-ionic surfactant;
wherein the composition has a pH of from 8.5 to 12,
wherein the at least one triamine-based antimicrobial agent is N-(3-aminopropyl)-N-dodecylpropane-1,3-diamine;
wherein the at least one pH-dependent anionic surfactant is selected from the group consisting of alkyl alaninates, alkyl glutamates, alkyl sarcosinates, alkyl glycinates, alkyl aspartates, and combinations thereof; and
wherein the at least one non-ionic surfactant is selected from the group consisting of ß-alanine, N-(2-carboxyethyl) N-coco alkyl derivatives, sodium N-(2-carboxyethyl)-N-(2-ethylhexyl)-β-alaninate, sodium N-(2-carboxyethyl)-N-octyl-β-alaninate, ß-alanine N-(2-carboxyethyl) N-tallow alkyl derivatives, sodium cocoyl alaninate, sodium lauroyl alaninate, sodium N-dodecanoyl-L-alaninate, and combinations thereof.

Optionally said composition comprises a buffering agent.

The at least one buffering agent may comprise at least one organic acid, preferably wherein the organic acid is a carboxylic acid preferably selected from the group consisting of acetic acid, glycolic acid, formic acid, citric acid, malic acid, maleic acid, lactic acid, tartaric acid, oxalic acid, and combinations thereof.

In one embodiment, the invention provides a disinfecting cleaning composition comprising
(a) at least one triamine-based antimicrobial agent;
(b) at least one pH-dependent anionic surfactant; and
(c) at least one non-ionic surfactant;
wherein the composition has a pH of from 8.5 to 12,
wherein the at least one triamine-based antimicrobial agent is N-(3-aminopropyl)-N-dodecylpropane-1,3-diamine;
wherein the at least one pH-dependent anionic surfactant is at least one amino acid-based surfactant; and
wherein the at least one non-ionic surfactant is selected from the group consisting of B sodium N-(2-carboxyethyl)-N-(2-ethylhexyl)-β-alaninate.

Optionally said composition comprises a buffering agent.

The at least one buffering agent may comprise at least one organic acid, preferably wherein the organic acid is a carboxylic acid preferably selected from the group consisting of acetic acid, glycolic acid, formic acid, citric acid, malic acid, maleic acid, lactic acid, tartaric acid, oxalic acid, and combinations thereof.

In one embodiment, the invention provides a disinfecting cleaning composition comprising
(a) at least one triamine-based antimicrobial agent;
(b) at least one pH-dependent anionic surfactant; and
(c) at least one non-ionic surfactant;
wherein the composition has a pH of from 8.5 to 12,
wherein the at least one triamine-based antimicrobial agent is N-(3-aminopropyl)-N-dodecylpropane-1,3-diamine;
wherein the at least one pH-dependent anionic surfactant is selected from the group consisting of alkyl alaninates, alkyl glutamates, alkyl sarcosinates, alkyl glycinates, alkyl aspartates, and combinations thereof;
wherein the at least one non-ionic surfactant is B sodium N-(2-carboxyethyl)-N-(2-ethylhexyl)-β-alaninate.

Optionally said composition comprises a buffering agent.

The at least one buffering agent may comprise at least one organic acid, preferably wherein the organic acid is a carboxylic acid preferably selected from the group consisting of acetic acid, glycolic acid, formic acid, citric acid, malic acid, maleic acid, lactic acid, tartaric acid, oxalic acid, and combinations thereof.

In one embodiment, the invention provides a disinfecting cleaning composition comprising
(a) at least one triamine-based antimicrobial agent;
(b) at least one pH-dependent anionic surfactant; and
(c) at least one non-ionic surfactant; wherein the composition has a pH of from 8.5 to 12,
wherein the at least one triamine-based antimicrobial agent is N-(3-aminopropyl)-N-dodecylpropane-1,3-diamine;
wherein the at least one pH-dependent anionic surfactant is at least one alkyl alaninate;
wherein the at least one non-ionic surfactant is selected from the group consisting of B sodium N-(2-carboxyethyl)-N-(2-ethylhexyl)-β-alaninate.

Optionally the said composition comprises a buffering agent.

The at least one buffering agent may comprise at least one organic acid, preferably wherein the organic acid is a carboxylic acid preferably selected from the group consisting of acetic acid, glycolic acid, formic acid, citric acid, malic acid, maleic acid, lactic acid, tartaric acid, oxalic acid, and combinations thereof.

In one embodiment, the invention provides a disinfecting cleaning composition comprising
(a) at least one triamine-based antimicrobial agent;
(b) at least one pH-dependent anionic surfactant; and
(c) at least one non-ionic surfactant;
wherein the composition has a pH of from 8.5 to 12,
wherein the at least one triamine-based antimicrobial agent is N-(3-aminopropyl)-N-dodecylpropane-1,3-diamine;
wherein the at least one pH-dependent anionic surfactant is sodium N-(2-carboxyethyl)-N-(2-ethylhexyl)-β-alaninate;
wherein the at least one non-ionic surfactant is B sodium N-(2-carboxyethyl)-N-(2-ethylhexyl)-β-alaninate.

Optionally the said composition comprises a buffering agent.

The at least one buffering agent may comprise at least one organic acid, preferably wherein the organic acid is a carboxylic acid preferably selected from the group consisting of acetic acid, glycolic acid, formic acid, citric acid, malic acid, maleic acid, lactic acid, tartaric acid, oxalic acid, and combinations thereof.

In one embodiment, the invention provides a disinfecting cleaning composition comprising
(a) at least one triamine-based antimicrobial agent;
(b) at least one pH-dependent anionic surfactant; and
(c) at least one non-ionic surfactant; and
(d) at least one buffering agent,
wherein the composition has a pH of from 8.5 to 12,
wherein the at least one triamine-based antimicrobial agent is N-(3-aminopropyl)-N-dodecylpropane-1,3-diamine;
wherein the at least one pH-dependent anionic surfactant is at least one alkyl alaninate;
wherein the at least one non-ionic surfactant is B sodium N-(2-carboxyethyl)-N-(2-ethylhexyl)-β-alaninate; and
wherein the at least one buffering agent comprises at least one organic acid, preferably wherein the organic acid is tartaric acid.

In one embodiment, the invention provides a disinfecting cleaning composition comprising
(a) at least one triamine-based antimicrobial agent;
(b) at least one pH-dependent anionic surfactant;
(c) at least one non-ionic surfactant; and
(d) at least one buffering agent,
wherein the composition has a pH of from 8.5 to 12,
wherein the at least one triamine-based antimicrobial agent is N-(3-aminopropyl)-N-dodecylpropane-1,3-diamine;
wherein the at least one pH-dependent anionic surfactant is at least one sodium N-(2-carboxyethyl)-N-(2-ethylhexyl)-β-alaninate;
wherein the at least one non-ionic surfactant is selected from the group consisting of B sodium N-(2-carboxyethyl)-N-(2-ethylhexyl)-β-alaninate; and
wherein the at least one buffering agent comprises at least one organic acid, preferably wherein the organic acid is tartaric acid.

### Uses

The disinfecting cleaning composition disclosed hereinabove can be used for cleaning various hard surfaces. The term “cleaning” refers to a method used to facilitate or aid in soil removal, bleaching, microbial population reduction, and any combination thereof.

All hard surfaces can be cleaned with the disinfecting cleaning composition of the invention, and all non-human or non-animal surfaces.

Such surfaces include, but are not limited to, those located in dairies, homes, health care facilities, swimming pools, canneries, food processing plants, restaurants, hospitals, institutions, and industry, including secondary oil recovery.

Suitable surface, which can be treated with a composition of the invention include, but are not limited to, any hard surface such as one made from glass, a metal such as an aluminum or stainless steel, a ceramic, a stone such as granite or marble, a plastic or polymer material, or the like.

The compositions of the invention offer good cleaning efficiency on both greasy and particulate soils. Oil and greasy soils adhere to the (floor) surfaces causing discoloration by attracting and holding dry soil. This type of soil can be classed as the worst type of soiling. The dye, such as e.g., from food or drink, can be absorbed into the (floor) surfaces resulting in a permanent stain, if left untreated. Particulate soils adhere to the surface as a consequence of van der Waals and related interactions between the contaminants and surface.

The disinfecting cleaning compositions can be used in any suitable industry or field. For instance, the disinfecting cleaning composition can be used in the food and beverage field. The disinfecting cleaning composition, for instance, may comprise a hard surface cleaner, a hand sanitizer, a sterilizing or high-level disinfecting cleaning composition, a pre-disinfectant cleaner for instruments and the like.

### EXAMPLES

### Example 1

The biocidal efficacy as well as the cleaning efficacy of the compositions of the invention has been determined as outlined below, and was compared to a Comparative “Composition A”, which differed from the composition of the invention merely in the nature of the surfactant used therein. While the compositions of the invention included a pH dependent anionic surfactant, the comparative composition used a permanently anionic surfactant. As derivable from FIGS. 1 and 2, the cleaning performance of all compositions was superior to water, and in parity with each other. However, the compositions of the invention exhibited significantly higher biocidal efficacy despite the presence of an anionic surfactant.

### Compositions of the Invention

Table 1 shows exemplary compositions of the invention and their ingredients.

Composition I (RTU C I) is a composition of the invention in the ready-to-use (RTU) form.

Composition C I.1 and Composition C II.1 are compositions of the invention; the specification “1:100 concentrate” means that the compositions may be diluted with 100 parts of water for use.

Composition I.2 (C I.2) and Composition II.2 (C II.2) are compositions of the invention, the specification “1:200 concentrate” means that each of the compositions maybe diluted with 200 parts of water for use.

TABLE 1
Compositions of the invention (all wt-% values quoted as actual levels of primary chemical constituent in the formulated composition).

| Ingredient/ | | | RTU | 1:100 CONCENTRATE | | 1:200 CONCENTRATE | |
|---|---|---|---|---|---|---|---|
| Tradename, | | | RTU C I | C I.1 | C II.1 | C I.2 | C II.2 |
| CAS No | Purpose | Primary Chemical Constituent | Wt-% | Wt-% | Wt-% | Wt-% | Wt-% |
| Deionised water | Solvent | Water | to 100 | to 100 | to 100 | to 100 | to 100 |
| 7732-18-5 | | | | | | | |
| Lonzabac 12.100 | Antimicrobial | N-(3-Aminopropyl)-N-dodecyl- | 0.068 | 6.8 | 6.8 | 13.6 | 13.6 |
| 2372-82-9 | Active | propane-1,3-diamine | | | | | |
| | Ingredient | | | | | | |
| Barlox 12 | Amphoteric | N-Alkyl(C6-18)-N,N- | 0.015 | 1.5 | 1.5 | 3.0 | 3.0 |
| 61788-90-7 | Surfactant | dimethyl-amine-N-oxide | | | | | |
| Lakeland AMA LF40 | pH-dependent | Sodium N-(2-carboxyethyl)-N- | 0.02 | 2.0 | | 4.0 | 4.0 |
| 94441-92-6 | anionic | (2-ethylhexyl)-β-alaninate | | | | | |
| Amphotensid EH | Surfactant | | | | 2.0 | | |
| 94441-92-6 | | | | | | | |
| Imbentin C/91/060 | Non- | Alcohols C9-11, ethoxylated 6EO | 0.054 | 5.4 | 5.4 | 10.8 | 10.8 |
| 68439-46-3 | ionic | | | | | | |
| | Surfactant | | | | | | |
| Trilon M | Chelating Agent | Alanine, N,N-Bis(carboxymethyl) | 0.028 | 2.8 | 2.8 | 5.6 | 5.6 |
| 164462-16-2 | | Trisodium Salt | | | | | |
| Tartaric Acid | Buffering Agent | Tartaric Acid | 0.038 | 1.8 | 1.9 | 3.7 | 3.7 |
| 87-69-4 | | | | | | | |
| pH | | | 9.1 | 10.0 | 10.0 | 10.1 | 10.1 |

### Comparative Composition

Table 2 shows the composition of a comparative “Composition A”.

Comparative “Composition A” is a “ready-to-use” composition, which has been diluted with 100 parts of water during to comprise 0.068 wt-% of a triamine-based antimicrobial agent (N-(3-Aminopropyl)-N-dodecylpropane-1.3-diamine), 0.03 wt-% of a non-ionic surfactant, and 0.014 wt-% of an anionic surfactant (i.e., a permanently anionic surfactant, not a pH-dependent surfactant as used in the compositions of the invention described above).

TABLE 2
Ingredients of the Comparative Composition A
(Ready-To-Use/RTU formulation)

| Ingredient/ | | | |
|---|---|---|---|
| Tradename, | | Primary | |
| CAS No | Purpose | Chemical Constituent | Wt-% |
| Deionized Water | Solvent | Water | To 100 |
| 7732-18-5 | | | |
| Lonzabac | Antimicrobial | N-(3-Aminopropyl)-N- | 0.068 |
| 12.100 | Active | dodecylpropane-1,3- | |
| 2372-82-9 | Ingredient | diamine | |
| Non-ionic | Surfactant | Isotridecanol 9 mol | 0.03 |
| surfactant | | Ethoxylate | |
| 69011-36-5 | | | |
| Anionic | Surfactant | Lauryl Diglycol Ether | 0.014 |
| surfactant | | Sulphate Sodium Salt | |
| 68891-38-3 | | | |
| Trilon M | Chelating | Alanine, N,N- | 0.028 |
| 164462-16-2 | agent | Bis(carboxymethyl) | |
| | | Trisodium Salt | |
| Purac FCC80 | Buffering | Lactic Acid | 0.024 |
| 79-33-4 | agent | | |
| pH | | | 9.5 |

All wt-% values quoted as actual levels of primary chemical constituent in the formulated composition.

### Biocidal Efficacy

The biocidal efficacy was tested by using the EN13697 European standard surface disinfection test under the I&I dirty conditions. This is a quantitative nonporous surface test for the evaluation of bactericidal and/or fungicidal activity of chemical disinfectants used in food, Industrial, domestic and institutional areas.

Table 3 shows a the biocidal efficacy of RTU C I of the invention and a diluted (RTU) form of Composition A comprising the same amount of the same amine-based microbial agent vs Pseudomonas aeruginosa, Escherichia coli, Staphylococcus aureus, Enterococcus hirae and Candida albicans. The results are quoted as average log reduction and % pass rate. Each measurement was conducted with 10 replicates per test point.

TABLE 3
Comparison of biocidal efficacy of the RTU compositions of the composition of the
invention (Composition I) and the comparative Composition A.

| | Minimum contact time to pass* EN13697 method vs core | | | |
|---|---|---|---|---|
| | organisms (based on average log reduction from 10 replicates) | | | |
| | | Average log | | Average log |
| | | reduction | | reduction |
| | Contact Time | achieved | Contact Time | achieved |
| Composition tested | Composition I (RTU) | | Comparative Composition A | |
| pseudomonas aeruginosa | 2 minutes | 4.2 (pass) | 4 minutes | 4.4 (pass) |
| escherichia coli | 2 minutes | 4.44 (pass) | NT | NT |
| staphylococcus aureus | 2 minutes | 4.17 (pass) | 4 minutes | 3.77 (fail) |
| enterococcus hirae | 2 minutes | 4.45 (pass) | NT | NT |
| candida albicans | 4 minutes | 3.28 (pass) | 4 minutes | 2.88 (fail) |

*pass criterion = 4 log reduction for bacteria. 3 log reduction for yeast

Composition RTU C I, which is representative of the compositions of the invention, exhibited high surface disinfection efficacy which was superior over the RTU comparative Composition A (diluted to have the same level of anitmicrobial active agent in both treatments). The requirements to achieve the passing rate in this test is a log reduction of 24 for bacteria (represented by Pseudomonas aeruginosa, Escherichia coli, Staphylococcus aureus, and Enterococcus hirae) and a log reduction of 23 for yeast (represented by Candida albicans) after a defined period of time.

Below these reduction rates the composition fails against the specific microorganism. It is well known that the antimicrobial efficacy of disinfectants invariably increases as the contact time with the target microorganism increases.

The data given in Table 3 show that Composition RTU C I according to the invention is superior over the RTU comparative Composition A visa-à-vis gram positive bacteria (Staphylococcus aureus) and visa-à-vis yeast (Candida albicans) as the log reduction of 24 for bacteria is achieved after 2 minutes (bacteria) or 4 minutes (yeast). Furthermore. Composition RTU C I achieved a similar log reduction gram negative bacteria (Pseudomonas aeruginosa) compared to RTU Composition A despite Composition I had a shorter contact time (2 minutes vs 4 minutes). Thus, Composition RTU C I exhibited superior efficacy against gram negative bacteria compared with Composition A.

### Cleaning Efficacy

The cleaning efficacy of a composition according to the invention, of water, and of comparative compositions A and B was conducted with an Elcometer scrub tester (Elcometer Model 1720 Abrasion & Washability Tester using a scrub rate of 37 cycles per minute) on a hard surface. The hard surface was prepared in that a layer of food-soil was baked onto said surface at 170° C. for 45 minutes.

The method is based on 20 scrubs with Elcometer scrub tester, which was used with a universal material clamp with a cloth, wherein 5 ml test product was given.

FIG. 1 depicts the hard surface after cleaning with the above testing compositions and water.

FIG. 2 is a column chart and depicts the results of the cleaning test as described in FIG. 1, where the cleaning efficacy on a hard surface a composition of the invention (Composition I) was compared with water and comparative disinfecting cleaning compositions A and B.

As may be derived by these FIGS. 1 and 2, the cleaning performance of the Composition I and of Compositions A and B was superior to water, and parity with each other.

What is claimed:

1. A disinfecting cleaning composition comprising
(a) at least one triamine-based antimicrobial agent;
(b) at least one pH-dependent anionic surfactant; and
(c) at least one non-ionic surfactant;
wherein the composition has a pH of from 8.5 to 12, and
wherein the at least one pH-dependent anionic surfactant has an isoelectric point (IEP) higher than pH 0 and lower than the pH of said disinfecting cleaning composition.

2. The disinfecting cleaning composition according to claim 1, wherein the at least one triamine-based antimicrobial agent is selected from the group consisting of N-(3-aminopropyl)-N-dodecylpropane-1,3-diamine, N-(3-aminopropyl)-N-decyl-1,3-propanediamine, N-(3-aminopropyl)-N-tetradecyl-1,3-propanediamine, and combinations thereof.

3. The disinfecting cleaning composition according to claim 1, wherein the at least one pH-dependent anionic surfactant is selected from the group consisting of alkyl carboxylates, alkyl ether carboxylates, alkyl propionates, alkyl ether propionates, amino acid-based surfactants, and combinations thereof.

4. The disinfecting cleaning composition according to claim 1, wherein the non-ionic surfactant is selected from the group consisting of fatty alcohol ethoxylates, alkyl glucosides, alkyl polyglucosides, fatty acid ethoxylates, alkylphenol ethoxylates, poly(ethylene oxide)-poly(propylene oxide) block copolymers and combinations thereof; and/or
wherein the non-ionic surfactant is selected from the group consisting of isotridecanol ethoxylate, C9-C11 alcohol ethoxylates, C12-C18 alcohol ethoxylates, and combinations thereof.

5. The disinfecting cleaning composition according to claim 1, further comprising at least one amphoteric surfactant,
wherein the amphoteric surfactant is selected from the group consisting of amine oxides, alkyl betaines, alkyl amidopropyl betaines and combinations thereof, and/or
wherein the amphoteric surfactant is selected from the group consisting of N-alkyl(C6-18)-N,N-dimethylamine-N-oxide, octyl dimethyl amine oxide, decyl dimethyl amine oxide, lauryl dimethyl amine oxide, cocoalkyl dimethyl amine oxide, myristyl dimethyl amine oxide, octyl dimethyl amine oxide, decyl dimethyl amine oxide, lauryl dimethyl amine oxide, isoalkyl dimethyl amine oxide tetradecyl dimethyl amine oxide, and cetyl dimethyl amine oxide.

6. The disinfecting cleaning composition according to claim 1, further comprising at least one buffering agent.

7. The disinfecting cleaning composition according to claim 6, wherein the buffering agent comprises at least one organic acid, wherein the organic acid is a carboxylic acid, selected from the group consisting of acetic acid, glycolic acid, formic acid, citric acid, malic acid, maleic acid, lactic acid, tartaric acid, oxalic acid, and combinations thereof.

8. The disinfecting cleaning composition according to e claim 1, wherein the ratio of the total amount of the at least one triamine-based antimicrobial agent to the total amount of surfactants comprised in said composition is between 1:1 to 1:4.

9. The disinfecting cleaning composition according to claim 1, comprising from 10 wt-% to 50 wt-% of said at least one pH-dependent anionic surfactant(s) based on the total weight of surfactants comprised in said composition.

10. The disinfecting cleaning composition according claim 1, further comprising at least one chelating agent, selected from the group comprising EDTA, MGDA, GLDA, NTA, β-ADA, IDHA, citrates, gluconates, polystyrene sulfonates, and combinations thereof.

11. The disinfecting cleaning composition according to e claim 1, which is essentially free of biocidal active quaternary ammonium compounds, and/or essentially free of non-aqueous solvents.

12. The disinfecting cleaning composition according to claim 1, which is in a diluted “ready-to-use” (“RTU”) form comprising the composition of claim 1 and water in a ratio of from 1:1 to 1:1000.

13. The disinfecting cleaning composition according to claim 12, which has a pH of from 8.5 to 10.5.

14. The disinfecting cleaning composition according to claim 12, comprising:
(a) said at least one triamine-based antimicrobial agent in an amount of from 0.05 wt-% to 0.1 wt-% based on the total weight of the composition;
(b) said at least one pH-dependent anionic surfactant in an amount of from 0.015 wt-% to 0.05 wt-% based on the total weight of the composition; and
(c) said at least one non-ionic surfactant in an amount of from 0.02 wt-% to 0.1 wt-% based on the total weight of the composition.

15. A method for disinfecting and/or cleaning a hard surface comprising use of the disinfecting cleaning composition according to claim 1.

16. The disinfecting cleaning composition according to claim 1, wherein the at least one triamine-based antimicrobial agent is N-(3-aminopropyl)-N-dodecylpropane-1,3-diamine.

17. The disinfecting cleaning composition according to claim 1, further comprising at least one amphoteric surfactant, wherein the at least one amphoteric surfactant is N-alkyl(C6-18)-N,N-dimethylamine-N-oxide.

18. The disinfecting cleaning composition according to claim 1, wherein the ratio of the total amount of the at least one triamine-based antimicrobial agent to the total amount of surfactants comprised in said composition is between 1:1 and 1:1.5.

19. The disinfecting cleaning composition according to claim 1, comprising from 20 wt-% to 25 wt-% of said at least one pH-dependent anionic surfactant(s) based on the total weight of surfactants comprised in said composition.

20. The disinfecting cleaning composition according to claim 1, which is free of biocidal active quaternary ammonium compounds, and/or free of non-aqueous solvents.
